(19) United States
(12) Patent Application Publication
(10) Pub. No.: US 2006/0116791 A1
(43) Pub. Date: Jun. 1, 2006

(54) Intelligent communication method and system for an irrigation/sprinkler system

(76) Inventors: Sharmila Ravula, Sunnyvale, CA (US); Madhuri Raya, Sunnyvale, CA (US); Yao Meng, Sunnyvale, CA (US); Karsten Funk, Stuttgart (DE)

Correspondence Address: KENYON & KENYON LLP, ONE BROADWAY, NEW YORK, NY, 10004, US

(21) Appl. No.: 11/000,150

(22) Filed: Nov. 29, 2004

(51) Int. Cl. G05D 7/00

(52) U.S. Cl. 700/284

(57) ABSTRACT

An intelligent local irrigation system includes one or more sprinklers and a controller coupled to the one or more sprinklers via a wired or wireless connection and enabled to control the sprinklers thereby. A controller arrangement establishes connectivity with an internet service portal which stores a profile of the local irrigation system and which obtains information from internet-based resources. The internet service portal determines an irrigation schedule based on the profile and on information obtained from the internet-based information resources and provides the irrigation schedule to the controller arrangement for implementation.

### FIELD OF THE INVENTION

The present application relates to a method and system for an intelligent communication method and system for an irrigation/sprinkler system, in which the implementation of water distribution can be controlled and/or configured using a communication service portal.

### BACKGROUND INFORMATION

In various geographical regions, water is a scarce resource. Irrigation systems used in such areas to be optimally designed to conserve water resources and should provide water at the most appropriate times.

It is believed of the irrigation systems in current use, which may employ timers for switching water valves on and off according to a preset schedule, may be sub-optimal in their use of water resources. For example, the preset schedule may not take into account local weather conditions or actual moisture present on site. Consequently, water may be wasted when irrigation occurs on rainy days, and insufficient amounts of water may be applied on particularly hot and dry days. Additionally, during freezing conditions, water may accumulate in irrigation supply pipes and may freeze, possibly causing damage to the pipes and to the irrigation system as a whole.

### SUMMARY OF THE INVENTION

An exemplary embodiment of the present invention provides an intelligent irrigation system that includes a local irrigation controller for connecting to an internet service for determining an amount of water to be distributed to one or more irrigation devices according to a local weather profile obtained from the internet service. In this regard, an exemplary intelligent irrigation system includes an internet service portal for storing a profile of the local irrigation controller and the one or more irrigation devices, the portal determining an irrigation schedule using the profile and local weather information.

In another aspect, an exemplary embodiment of the intelligent irrigation system according to the present invention may include a local irrigation system having one or more sprinklers and a controller coupled to the one or more sprinklers and enabled to control the sprinklers thereby, the controller further enabled to establish connectivity over a data network. The intelligent irrigation system may also include an internet service portal that may store a profile of the local irrigation system and may be coupled to one or more internet-based information resources. According to this exemplary embodiment, the internet service portal may be configured to determine an irrigation schedule based on the profile and on information obtained from the internet-based information resources and to deliver the irrigation schedule to the controller for implementation.

In an exemplary embodiment, an intelligent irrigation system may further include one or more sensors enabled to determine ambient conditions at the local irrigation system, the ambient conditions including one or more of humidity, temperature, moisture and soil conditions. In a particular embodiment, the one or more sensors are included at each sprinkler of the local irrigation system. In another exemplary embodiment, the one or more sensors are incorporated in a stand-alone sensor module situated at the local irrigation system.

In another exemplary embodiment of an intelligent irrigation system, the internet-based information resources may include one or more of a weather information server, a gardening information server, and a water and/or utility services server.

In yet another exemplary embodiment, the intelligent irrigation system may provide a controller having a processor, a memory unit and an arrangement for establishing a direct connection to the internet. The controller may obtain local weather information directly from internet-based information resources and then determine an irrigation schedule using the local weather information and measurements from the one or more sensors.

Another embodiment of an intelligent irrigation system according to the present invention may provide a home personal computer that operates as a gateway between the local irrigation system and the internet service portal. According to a particular embodiment, the home personal computer may store irrigation schedule information such that if connectivity to the internet is lost, the home computer implements an irrigation schedule using the stored irrigation schedule information.

In yet another exemplary embodiment, the portal may update the irrigation schedule on a periodic basis.

In still another exemplary embodiment, the irrigation schedule may include instructions as to the timing of irrigation and an amount of water to be provided for each of the sprinklers in the local irrigation system on an individualized basis.

In still another exemplary embodiment, the portal may provide precautionary commands to the local irrigation to switch off water supply during frost conditions.

In yet another exemplary embodiment, the portal may provide advice for optimizing irrigation based on information received from one or more of a gardening information server and a water and utility services server.

An exemplary method for determining an optimized irrigation schedule at a local irrigation system may include establishing a connection to an internet server and obtaining an irrigation schedule from the internet server using information regarding the local irrigation system and local weather information in determining the irrigation schedule.

According to the exemplary method, the internet server may obtain information from one or more of a weather information server, a gardening information server and a water and utility services server and may use the information in determining the irrigation schedule.

According to another exemplary method, information regarding ambient conditions at the local irrigation system may be sent to the internet server.

According to yet another exemplary method, the local irrigation system may include one or more irrigation devices and the irrigation schedule may be tailored individually for each of the irrigation devices.

In another aspect, the exemplary method of the present invention provides for determining an optimized irrigation schedule at a local irrigation system in which a connection may be established to an internet server, information may be obtained regarding local weather conditions from the internet server, and an irrigation schedule for the local irrigation system may be determined using the information regarding local weather conditions.

In the exemplary embodiment of the method, irrigation schedule information may be stored, and if the connection is broken, an updated irrigation schedule may be determined based on the stored irrigation schedule information.

### BRIEF DESCRIPTION OF THE DRAWINGS

FIG. 1 shows an exemplary embodiment of an intelligent irrigation system according to the present invention.

FIG. 2 shows another exemplary embodiment of an intelligent irrigation system according to the present invention in which an irrigation system controller is coupled directly to the Internet.

FIG. 3 shows another exemplary embodiment of an intelligent irrigation system according to the present invention.

FIG. 4 shows a flow chart of an exemplary implementation of an intelligent irrigation method according to the present invention.

FIG. 5 shows a schematic block diagram of a controller of a local irrigation system according to an exemplary embodiment of the present invention.

### DETAILED DESCRIPTION

According to the exemplary embodiment of the present invention, an intelligent irrigation system is connected to an Internet service to obtain configuration instructions and local weather information (collectively “information”). The irrigation system uses this information to optimize the irrigation process depending on the user's needs and local weather conditions.

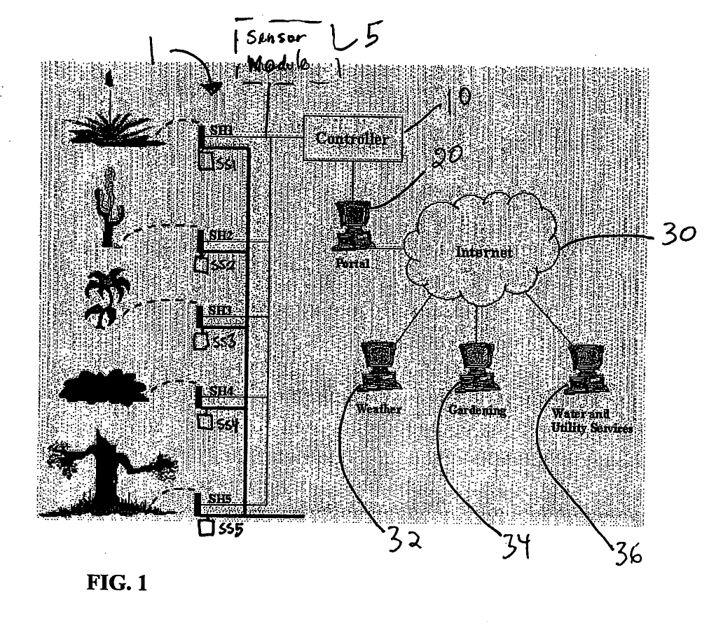

FIG. 1 shows a first embodiment of an intelligent irrigation system according to the present invention. As shown, a local irrigation system 1, which may be installed at a residence, includes an exemplary set of sprinklers (or termed “irrigation devices”) SH1, SH2, SH3, SH4, SH5 which may be distributed to provide selectively water to different parts of a lawn, garden, etc. Each of the sprinklers SH1, SH2, SH3, SH4, SH5 may include a corresponding sensor suite SS1, SS2, SS3, SS4, SS5, each of which can take measurements directly at each sprinkler. For example, one sprinkler may be located near a section of a garden where water tends to accumulate relative to other sections, and may thus be subject to different moisture and temperature conditions. Accordingly, the sensor suites SS1, SS2, SS3, SS4, SS5 may each include, for example, moisture, humidity, light, rain, temperature and soil condition sensors to better ascertain specific conditions. However, where such specificity is not a significant concern, the sensors may be incorporated in a separate sensor module 5 instead of each sprinkler.

The local irrigation system 1 also includes a controller arrangement 10 coupled via a wired or wireless connection to each of the sprinklers SH1, SH2, SH3, SH4, SH5. A wireless connection between the sprinklers SH1, SH2, SH3, SH4, SH5 and the controller 10 may be implemented with a dedicated wireless communication system which may be similar to those of building security systems, or alternatively, a wireless protocol based on 802.11x, UWB and/or Bluetooth technology may be employed.

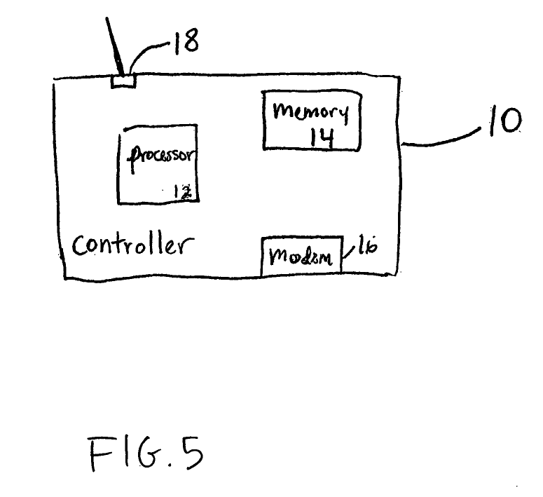

FIG. 5 shows an exemplary block diagram of a controller 10 of the local irrigation system 1. As shown, the controller 10 includes a processor 12 that may range in capability from a relatively low-power processor with limited processing and decision-making capability to a high-power CPU with considerable processing capability. A memory unit 14, which may include flash memory or other RAM components, is also included. To limit the cost of the controller 10, the capacity of the memory unit 14 may be limited. The controller 10 also includes either a dial-up (telephone) and/or broadband (cable, DSL) modem 16 for communication with an external network, as well as a communication device 18 allocated for the local irrigation communication system.

Given the wide range of processing capabilities of a controller according to the present invention, the functionality of the controller may range from simple to intelligent. A relatively simple controller may keep track of the positions of the various sprinklers without obtaining and/or processing a large amount of measurements from either sprinkler sensors or a sensor module. Such a controller may obtain information from a home PC or Internet server as described below. In this case, the “home” conditions such as moisture content and soil conditions would not be taken into account or considered in determining the irrigation schedule. An intelligent controller, however, may collect the measurement data from the sensor modules of the sprinklers (or the stand-alone module), analyze this data in combination with the information received concerning weather conditions, plant profiles, public utility services etc., and then determine irrigation levels for each sprinkler. This could minimize the information sent over the network by localizing certain decision-making processes.

Referring again to FIG. 1, the controller 10 is coupled to an Internet server 20 (hereinafter referred to as “the portal”) via a telephone or broadband connection. The portal is a computer operating server software that receives and stores a profile of the local irrigation system 1. An exemplary profile is shown below in Table I. The user can set the profile by contacting the portal using any web browser. The portal is coupled to the Internet 30 to which it may send queries periodically to such online information resources as a weather information server 32, a gardening information server 34 and a water and/or utility services server 36.

The first field of the user profile is the Unique Identification (UID), which uniquely identifies the controller of the local irrigation system and therefore enables the portal to address properly packets of information to the appropriate controller. The geographic location field indicates the city (or other local geographic entity such as a county) where the local irrigation system is located. This field determines the weather profile as well as statistics and averages for sunshine, temperatures, humidity, etc. The configuration field(s) enables the user to select certain options such as the frequency at which the portal receives updates from the online information resources. In the exemplary table shown, the configuration (I) field is set for daily updates. Although only one configuration field is shown in Table I, this should not be construed as limiting since any number of configuration fields may be used to select other configuration options. The irrigation system profile also includes an itinerary of the locations of each of the sprinklers in the local irrigation system. This enables the user to specify the plants each sprinkler is irrigating (e.g. “lawn in front of house”, “cactus in back of house”, “flower bed on side of house”, etc.). In this manner, configuration of the profile allows the user to tailor water needs individually for each and every sprinkler separately.

TABLE I
IRRIGATION SYSTEM USER PROFILE

| | |
|---|---|
| Unique Identification (UID) | WR0410X |
| Geographic Location | San Jose, CA |
| Configuration 1 | daily inquiry |
| Sprinkler 1 | Grass on lawn, front of house |
| Sprinkler 2 | Cactus, back of house |
| Sprinkler 3 | Flower bed, right side of house |
| Sprinkler 4 | Bushes, left side of house |
| Sprinkler 5 | Tree, backyard |

At the portal 20, an irrigation schedule is determined that includes both the amount of water to be provided and the times at which water is to be provided at each of the sprinklers of the local irrigation system 1. The portal 20 determines the schedule primarily based on the weather conditions and forecast obtained via the weather information server 32, the types of plants in the user profile, and previous irrigation instructions transmitted from the portal.

Additionally, other information resources can be used to optimize irrigation. For example, the portal 20 can connect to the local water and/or utility services server 36 to check for water prices, availability and irrigation regulations. This information can be useful to ensure minimal irrigation to keep plants alive even during droughts and can also provide cost savings by incorporating favorable utility rebates and/or subsidies into the planned irrigation schedule. In addition to determining the irrigation schedule, the portal 20 can provide advice to the user regarding the best time to plant, optimal irrigation schedules, pest vulnerability, disease control and fertilizing schedules using the plant profiles in the user profile. The portal 20 can also send alerts that include such information to the user via periodic email notifications. The portal 20 may also send out alerts and implement precautionary measures during poor weather conditions. For example, in case of frost, the portal may send instructions to the controller 10 to switch off water flow to avoid pipe bursts.

The functionality of the portal 20 can be enhanced with the availability of sensor modules attached to the sprinkler system. When the controller arrangement 10 transmits sensor measurements of soil conditions and moisture to the portal 20, it can incorporate this information with local weather forecast in determining the irrigation schedule and in providing additional information. Additionally, by accessing the gardening information server 34, the portal 20 can also suggest other plant varieties appropriate for the particular soil and weather conditions at the local irrigation system 1 to optimize cultivation.

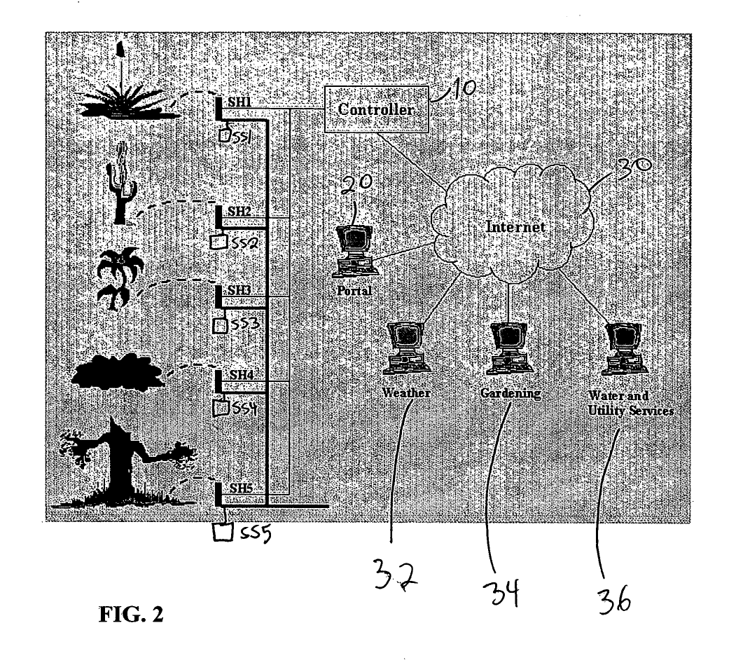

FIG. 2 illustrates another exemplary embodiment of an intelligent sprinkler system according to the present invention in which the controller 10 is coupled directly to the Internet via a broadband connection. In this case, the controller 10 may be an “intelligent controller” that can collect information from the sensor modules (SS1, SS2 etc.) of the sprinklers but can also obtain web-based information from the portal 20. Using this combination of collected information, the controller in this embodiment may determine an irrigation schedule including irrigation levels for each of the sprinklers SH1, SH2 etc. This embodiment has the advantages that it minimizes the amount of information sent over the Internet and localizes decision-making.

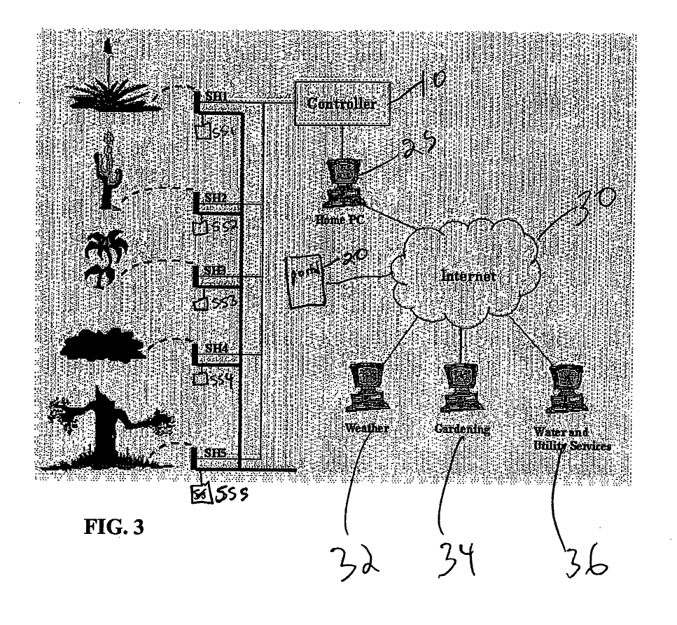

FIG. 3 illustrates yet another exemplary embodiment of an intelligent sprinkler system according to the present invention in which a home personal computer (“home PC”) 25 can be set up as a gateway between the local irrigation system 1 and the service portal 20. The home PC gateway 25 executes software that enables connectivity to the controller arrangement 10 via a compatible interface or PC adapter (according to available standards and protocols) and to the service portal 20 via the Internet. According to this embodiment, the home PC gateway may receive irrigation instructions from the service portal as determined by weather, plant profile, gardening knowledge base, public utility services, etc., and controls the sprinklers based on these instructions. The whole process may be automated without any manual intervention, while users can customize the service via configuration options at the home PC 25. Thus, the user does not necessarily need to log in to the portal 20 to reconfigure the irrigation schedule.

Furthermore, the home PC 25 can also serve as a “home gardener” when an Internet connection is lost and the portal 20 cannot be accessed. For example, users may have the option to configure the home PC 25 to store the last-used irrigation values as a backup measure. The home PC can also store a significant amount of plant profile, gardening and weather forecast information. Accordingly, if and when Internet connectivity breaks down or users decide to minimize service cost by reducing the connectivity to the service portal 20 from e.g., daily to every other day or weekly, the home PC 25 can make use of the locally stored profile and forecasted weather information to control the irrigation process.

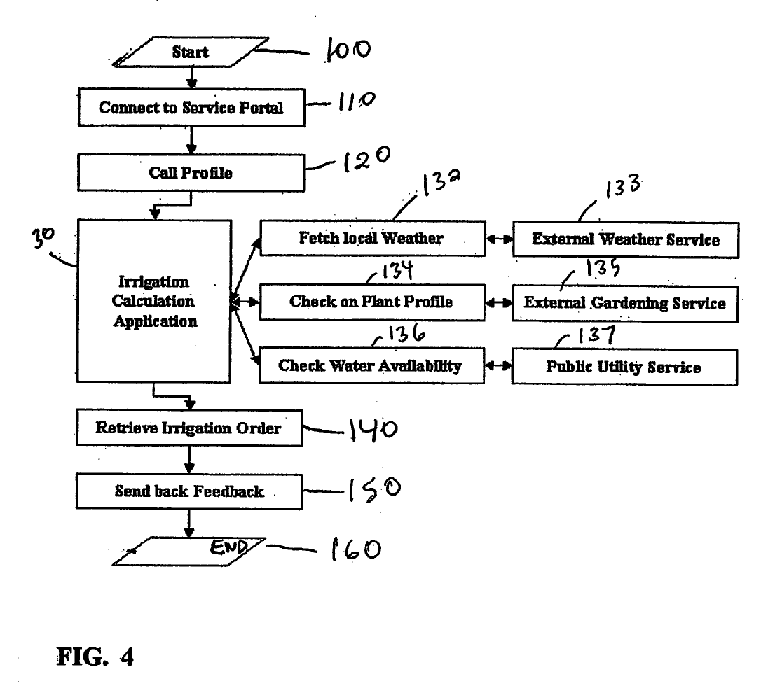

FIG. 4 illustrates a flow chart of an exemplary implementation of an intelligent irrigation method according to the present invention. Upon commencement (step 100), the irrigation system controller establishes a connection to the portal or home PC (step 110). Once connected, the user profile is accessed (step 120) and an irrigation calculation application is executed (step 130). At this stage, the controller arrangement 10 may also send local sensor measurement information to the portal. The irrigation calculation application fetches local weather information (step 132) via a connection with an external weather service (step 133); checks on the user plant profile (step 134) and simultaneously contacts an external gardening information service (step 135); and checks local water availability (step 136) via a public utility service (step 137). Using the information gathered from all of these sources, the irrigation calculation application determines an irrigation schedule. The schedule is compiled as a set of irrigation commands (step 140) which is then sent back to the controller (step 150). The process ends at step 160.

1. An irrigation system, comprising:
a local irrigation controller for connecting to an internet service for determining an amount of water to be distributed individually to each of at least one irrigation device according to a local weather information obtained from the internet service; and
an internet service portal which stores a profile of the local irrigation controller and the at least one irrigation device, the portal determining an irrigation schedule that includes instructions as to a timing of the irrigation and an amount of water to be provided for each of the at least one irrigation device on an individual basis.

2. (canceled)

3. An irrigation system, comprising:
a local irrigation system including:
at least one sprinkler; and
a controller arrangement coupled to the at least one sprinkler to control the sprinklers, establishing connectivity over a data network; and
an internet service portal coupled to the data network for storing a profile of the local irrigation system and being coupled to at least one internet-based information resource for determining an irrigation schedule based on the profile and on information obtained from the internet-based information resource and for providing the irrigation schedule to the controller arrangement for implementation,
wherein the irrigation schedule includes instructions as to a timing of the irrigation and an amount of water to be provided for each of the at least one sprinkler in the local irrigation system on an individual basis.

4. The irrigation system of claim 3, wherein the local irrigation system includes at least one sensor to determine an ambient condition at the local irrigation system, the ambient condition including at least one of a humidity condition, a temperature condition, a moisture condition and a soil condition.

5. The irrigation system of claim 4, wherein the at least sensor is included at each of the at least one sprinkler of the local irrigation system.

6. The irrigation system of claim 4, wherein the at least one sensor us included in a stand-alone sensor module coupled to the local irrigation system.

7. The irrigation system of claim 3, wherein the at least one internet-based information resource includes at least one of a weather information server, a gardening information server, a water services server and a utility services server.

8. The irrigation system of claim 4, wherein the controller includes a processor, a memory arrangement and a connecting arrangement for establishing a direct connection to the internet for obtaining local weather information directly from the at least one internet-based information resource and for determining an irrigation schedule based on the local weather information and measurements from the at least one sensor.

9. The irrigation system of claim 3, further comprising:
a home personal computer which operates as a gateway between the local irrigation system and the internet service portal.

10. The irrigation system of claim 9, wherein the home personal computer is operable to store irrigation schedule information so that if connectivity to the internet is lost, the home computer implements an irrigation schedule using the stored irrigation schedule information.

11. The irrigation system of claim 3, wherein the portal is operable to update the irrigation schedule on a periodic basis.

12. (canceled)

13. The irrigation system of claim 3, wherein the portal is operable to provide precautionary commands to the local irrigation to switch off water supply during a frost condition.

14. The irrigation system of claim 3, wherein the portal is operable to provide advice for optimizing the irrigation based on information received from at least one of a gardening information server, a water services server and a utility services server.

15. A method of determining an optimized irrigation schedule at a local irrigation system, the method comprising:
establishing a connection to an internet server; and
obtaining an irrigation schedule from the internet server, the internet server using information regarding the local irrigation system and local weather information in determining the irrigation schedule,
wherein the local irrigation system includes at least one irrigation device and the irrigation schedule is determined individually for each of the at least one irrigation device.

16. The method of claim 15, wherein the internet server obtains information from at least one of a weather information server, a gardening information server, a water services server and a utility services server and uses the information to determine the irrigation schedule.

17. The method of claim 15, further comprising:
determining ambient condition information at the local irrigation system; and
providing the ambient condition information to the internet via at least one of a portal and a personal computer.

18. (canceled)

19. A method of determining an irrigation schedule at a local irrigation system, the method comprising:
establishing a connection to an internet server;
obtaining information regarding local weather conditions from the internet server; and
determining an irrigation schedule for the local irrigation system using the information regarding local weather conditions,
wherein the local irrigation system includes at least one irrigation device and the irrigation schedule is determined individually for each of the at least one irrigation device.

20. The method of claim 19, further comprising:
storing irrigation schedule information;
if the connection with the internet server is broken, determining an updated irrigation schedule based on the stored irrigation schedule information.
